(19) United States
(12) Patent Application Publication
(10) Pub. No.: US 2019/0335166 A1
(43) Pub. Date: Oct. 31, 2019

(54) DERIVING 3D VOLUMETRIC LEVEL OF INTEREST DATA FOR 3D SCENES FROM VIEWER CONSUMPTION DATA

(71) Applicant: Imeve Inc., San Francisco, CA (US)

(72) Inventors: Devon Copley, San Francisco, CA (US); Prasad Balasubramanian, Fremont, CA (US)

(73) Assignee: Imeve Inc., San Francisco, CA (US)

(21) Appl. No.: 16/393,369

(22) Filed: Apr. 24, 2019

Related U.S. Application Data
(60) Provisional application No. 62/662,510, filed on Apr. 25, 2018.

(51) Int. Cl. H04N 13/368; G06T 15/08; G06F 3/01; H04N 5/232; H04N 13/183; G06T 15/20; H04N 13/243; H04N 13/296; H04N 13/167; H04N 13/161; G06T 9/00

(52) U.S. Cl. CPC H04N 13/368; G06T 15/08; G06F 3/013; H04N 5/23299; H04N 13/183; G06T 15/20; G06F 3/012; H04N 13/296; H04N 13/167; H04N 13/161; G06T 9/00; G06T 2200/04; H04N 13/243

(57) ABSTRACT

Described herein are methods and systems for identifying and using 3D volumetric level of interest data associated with a 3D scene being viewed by multiple viewers. The method can include obtaining, for a time slice, respective consumption data associated with each viewer, of a plurality of viewers that are viewing the 3D scene. The method can also include identifying, based on the consumption data, 3D volumetric level of interest data associated with each of the viewers that are viewing the 3D scene, and thereby, identifying a plurality of separate instances of 3D volumetric level of interest data for the time slice. The method can additionally include aggregating the 3D volumetric level of interest data associated with two or more of the viewers and using the aggregated volumetric level of interest data to autonomously control an aspect associated with the 3D scene for the time slice and/or a later time slice.

### PRIORITY CLAIM

This application claims priority to U.S. Provisional Patent Application No. 62/662,510, filed Apr. 25, 2018, which is incorporated herein by reference.

### TECHNOLOGICAL FIELD

Embodiments of the present technology generally relate to the field of electronic imagery, video content, and three-dimensional (3D) or volumetric content, and more particularly to deriving 3D volumetric level of interest data for a 3D scene from viewer behavior, and the applications of such 3D volumetric level of interest data.

### BACKGROUND

The determination of areas of visual content which are of greatest interest to viewers has been shown to have wide utility. Gaze tracking systems have long been deployed to track viewers' attention across standard planar video displays, and this data is regularly used for a variety of purposes. More recently, in the field of virtual reality, both head rotation and gaze tracking data have been used to generate aggregated “heat maps,” showing the areas of spherical content which attract the most user interest over time. This data is used for everything from improving compression efficiency to identifying the best locations for advertising placement.

### BRIEF SUMMARY

Certain embodiments of the present technology relate to methods for identifying and using three-dimensional (3D) volumetric level of interest data associated with a 3D scene that is being viewed by multiple viewers. Such a method can include obtaining, for a time slice, respective consumption data associated with each viewer, of a plurality of viewers that are viewing the 3D scene. The method can also include identifying for the time slice, based on the consumption data, 3D volumetric level of interest data associated with each of the viewers that are viewing the 3D scene, and thereby, identifying a plurality of separate instances of 3D volumetric level of interest data for the time slice. The method can further include aggregating the 3D volumetric level of interest data associated with two or more of the viewers for each of one or more locations within the 3D scene for the time slice. Additionally, the method can include using the aggregated volumetric level of interest data to autonomously control an aspect associated with the 3D scene for at least one of the time slice or a later time slice.

In accordance with certain embodiments, where the 3D scene that is being viewed is a computer rendered virtual scene, using the aggregated volumetric level of interest data to autonomously control an aspect associated with the 3D scene includes, for at least one of the time slice or a later time slice, autonomously controlling a location of at least one virtual capture device that is used to capture content of the 3D scene that is viewable by the multiple viewers. Additionally or alternatively, for at least one of the time slice or a later time slice, one or more 3D volume(s) of high interest is rendered at a higher resolution than another portion of the 3D scene that is outside the 3D volume(s) of high interest. Alternatively, or additionally, for at least one of the time slice or a later time slice, image data associated with one or more 3D volume(s) of high interest is compressed at a lower compression ratio than another portion of the 3D scene that is outside the 3D volume(s) of high interest.

In accordance with certain embodiments, where the 3D scene that is being viewed is a real-world scene, using the aggregated volumetric level of interest data to autonomously control an aspect associated with the 3D scene includes, for at least one of the time slice or a later time slice, autonomously controlling a location of at least one real-world capture device that is used to capture content of the 3D scene that is viewable by the multiple viewers. Examples of such real-world capture devices (whose location can be controlled autonomously) include, but are not limited to, a SkyCam, a cable-mounted camera, or a drone camera. Additionally, or alternatively, for at least one of the time slice or a later time slice, the aggregated volumetric level of interest data is used to autonomously controlling pan, tilt and/or zoom of at least one capture device (e.g., camera) that is used to capture content of the 3D scene that is viewable by the multiple viewers. Additionally, or alternatively, for at least one of the time slice or a later time slice, the aggregated volumetric level of interest data is used to autonomously add contextual information about a person or object within a 3D volume of high interest so that the added contextual information is viewable by the multiple viewers. Such contextual information can be statistical information and/or background information about a person or object within the 3D volume of high interest, but is not limited thereto.

In accordance with certain embodiments, each of at least some of the viewers is using a respective viewing device to view the 3D scene, and at least some of the consumption data is provided by one or more of the viewing devices. Examples of such viewing devices include, but are not limited to, a head mounted display, a television, a computer monitor, and/or a mobile computing device.

In accordance with certain embodiments, at least some of the viewers are local viewers of a real-world event, such as an actual soccer game. In such embodiments, at least some of the consumption data can be provided by one or more sensors attached to one or more local viewers. Additionally, or alternatively, at least some of the consumption data can be provided by one or more cameras trained on one or more local viewers.

In accordance with certain embodiments, at least some of the viewers are viewing a computer rendered 3D scene from a virtual camera point of view. In such embodiments, at least some of the consumption data is provided by one or more sensors attached to one or more viewers that is/are viewing the computer rendered 3D scene. Additionally, or alternatively, at least some of the consumption data is provided by one or more cameras trained on one or more viewers that is/are viewing the computer rendered 3D scene.

A system according to certain embodiments of the present technology is configured to identify and use three-dimensional (3D) volumetric level of interest data associated with a 3D scene that is being viewed by multiple viewers. The system comprises one or more processors configured to obtain, for a time slice, respective consumption data associated with each viewer, of a plurality of viewers that are viewing the 3D scene. The one or more processors is/are also configured to identify for the time slice, based on the consumption data, 3D volumetric level of interest data associated with each of the viewers that are viewing the 3D scene, and thereby, identifying a plurality of separate instances of 3D volumetric level of interest data for the time slice. The one or more processors is/are also configured to aggregate the 3D volumetric level of interest data associated with two or more of the viewers for each of one or more locations within the 3D scene for the time slice. Additionally, the one or more processors is/are configured to use the aggregated volumetric level of interest data to autonomously control an aspect associated with the 3D scene for at least one of the time slice or a later time slice.

In accordance with certain embodiments, at least some of the consumption data is provided by a viewing device, such as, but not limited to, a head mounted display, a television, a computer monitor, and/or a mobile computing device. Such viewing devices can be part of the system, or external to (but in communication with) the system.

In accordance with certain embodiments, the 3D scene that is being viewed by multiple viewers comprises at least a portion of a real-world event, and at least some of the consumption data is provided by one or more sensors attached to one or more local viewers and/or by one or more cameras trained on one or more local viewers. Such sensors can be part of the system, or external to (but in communication with) the system.

In accordance with certain embodiments, at least some of the viewers are viewing a computer rendered 3D scene from a virtual camera point of view, and at least some of the consumption data is provided by one or more sensors attached to one or more viewers that is/are viewing the computer rendered 3D scene, and/or at least some of the consumption data is provided by one or more cameras trained on one or more viewers that is/are viewing the computer rendered 3D scene. Such cameras can be part of the system, or external to (but in communication with) the system.

In accordance with certain embodiments, the one or more processors of the system is/are configured to use the aggregated volumetric level of interest data, to autonomously control an aspect associated with the 3D scene for at least one of the time slice or a later time slice, in at least one the following manners: to render one or more 3D volume(s) of high interest at a higher resolution than another portion of the 3D scene that is outside the 3D volume(s) of high interest; to compress image data associated with one or more 3D volume(s) of high interest at a lower compression ratio than another portion of the 3D scene that is outside the 3D volume(s) of high interest; to autonomously control pan, tilt and/or zoom of at least one capture device that is used to capture content of the 3D scene that is viewable by the multiple viewers; to autonomously control a location of at least one real-world capture device that is used to capture content of the 3D scene that is viewable by the multiple viewers; to autonomously add contextual information about a person or object within a 3D volume of high interest so that the added contextual information is viewable by the multiple viewers; and/or to autonomously control a location of at least one virtual capture device that is used to capture content of the 3D scene that is viewable by the multiple viewers.

In accordance with certain embodiments, the one or more processors of the system is/are configured to aggregate the 3D volumetric level of interest data, associated with two or more of the viewers for each of one or more locations within the 3D scene for the time slice, by identifying where at least some of a plurality of separate 3D volumes of interest identified for the time slice overlap one another.

In accordance with certain embodiments, the 3D scene comprises a real-world scene captured using a plurality of capture devices that each have a respective viewpoint that differs from one another, at least some of the viewers are using viewing devices to view the 3D scene based on one or more video feeds generated using at least one capture device, and each time slice corresponds to a frame of video captured by at least one of the one or more capture devices.

In accordance with certain embodiments, the 3D scene comprises a computer rendered virtual scene, each time slice corresponds to a rendered frame of the virtual scene, and each of the viewers views the computer rendered virtual scene from a respective viewpoint that can differ from one another.

Certain embodiments of the present technology are directed to one or more processor readable storage devices having instructions encoded thereon which when executed cause one or more processors to perform a method for identifying and using three-dimensional (3D) volumetric level of interest data associated with a 3D scene that is being viewed by multiple viewers, the method comprising: for a time slice, obtaining respective consumption data associated with each viewer, of a plurality of viewers that are viewing the 3D scene; identifying for the time slice, based on the consumption data, 3D volumetric level of interest data associated with each of the viewers that are viewing the 3D scene, and thereby, identifying a plurality of separate instances of 3D volumetric level of interest data for the time slice; aggregating the 3D volumetric level of interest data associated with two or more of the viewers for each of one or more locations within the 3D scene for the time slice; and using the aggregated volumetric level of interest data to autonomously control an aspect associated with the 3D scene for at least one of the time slice or a later time slice.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the Background.

### BRIEF DESCRIPTION OF THE DRAWINGS

FIG. 1 is a high level schematic block diagram that is used to shown an exemplary system with which embodiments of the present technology can be used.

FIG. 2 is a high level schematic block diagram that is used to shown an exemplary 360-degree camera type capture device with which embodiments of the present technology can be used.

FIG. 3. illustrates how frames of a full 360-degree video segment may be represented in an equirectangular projection.

FIG. 4 illustrates how a two-dimensional (2D) “attention area” may be visualized by superimposing it upon an equirectangular projection, such as the equirectangular projection introduced in FIG. 3.

FIG. 5 illustrates how a 2D “heat map” can be overlaid on an equirectangular projection, such as the equirectangular projection introduced in FIG. 3.

FIG. 6 illustrates how multiple wide field of view capture points can be positioned around a periphery of a scene in order to obtain multiple separate visual feeds of the same scene, with each of the visual feeds corresponding to a different viewpoint in actual or virtual space.

FIG. 7, which shows the same scene introduced in FIG. 6, illustrates how an exemplary single-view-point attention volume can be determined based on a single capture point's visual feed for a single moment in time.

FIG. 8, which shows the same scene introduced in FIG. 6 and shown in FIG. 7, illustrates how an exemplary multiple-view-point attention volume can be determined based on multiple capture points' visual feeds for a single moment in time.

FIG. 9, which is similar to FIG. 8, is used to explain how a voxel-based approach can be employed, wherein the relevant scene volume is divided into three-dimensional cubes, with each cube assigned a scalar value corresponding to the combined attention directed towards that voxel from all viewers.

FIG. 10 illustrates how consumption data can be derived from local viewers of a real-world event, rather than being derived from viewers of video feeds, and used as input(s) to an attention volume generation system.

FIG. 11 is a high level flow diagram that is used to summarize autonomous camera management and switching, according to certain embodiments of the present technology.

FIG. 12 is a high level flow diagram that is used to summarize autonomous positioning of capture device(s) in three dimensional space so as to bring them closer to high-attention areas, according to an embodiment of the present technology.

FIG. 13 is a high level flow diagram that is used to summarize methods according to various embodiments of the present technology.

### DETAILED DESCRIPTION

Certain embodiments of the present technology described herein relate to methods, systems, apparatuses, and computer program products for generating three-dimensional (3D) volumetric maps of user attention within a real or virtual space. Such methods will often be referred to below as attention volume generation processes. In contrast to prior processes that identify two-dimensional (2D) areas of content which attract various levels of user interest over time, certain embodiments of the present technology can be used to identify 3D volumes within a real or virtual space which attract various levels of user interest over time, which 3D areas are also referred to herein “attention volumes”. In other words, the term “attention volume,” as used herein, refers to a data specifying a relative amount of user interest attributed to one or more spatial locations within a three-dimensional (3D) volume. This data may also specify changes in user interest across the locations within the volume over time.

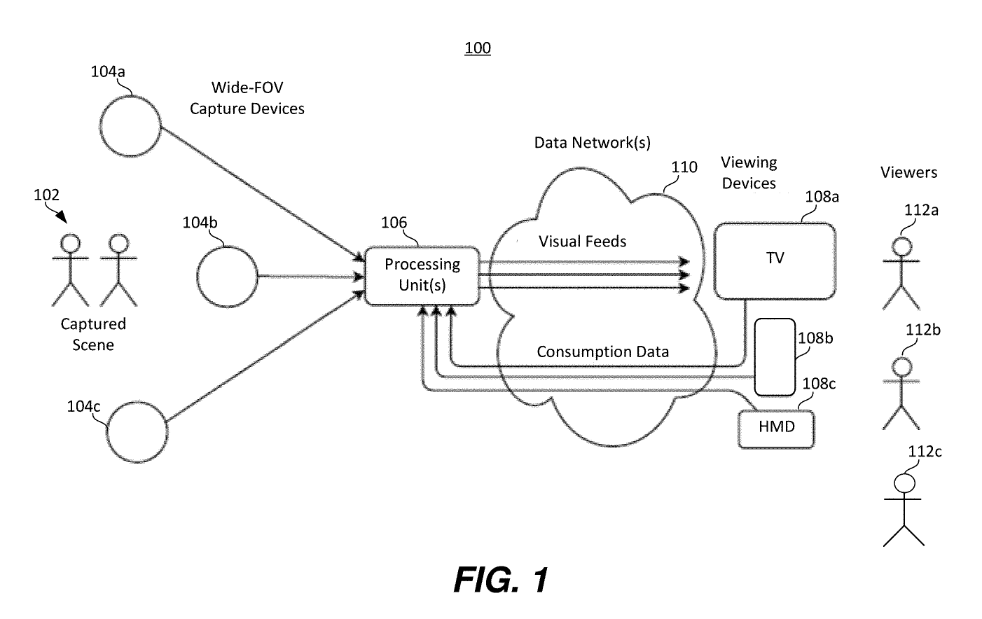

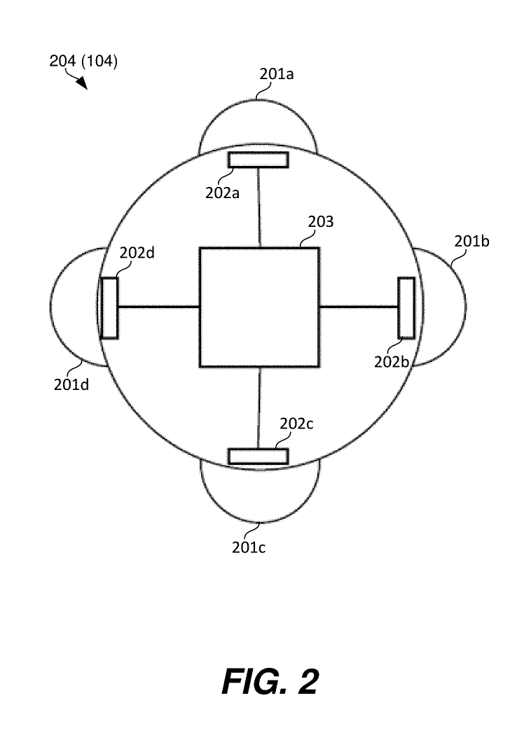

However, prior to providing details of such embodiments, an exemplary system that can be used to practice embodiments of the present technology will be described with reference to FIG. 1. Additionally, exemplary details of an apparatus that can be used to practice embodiments of the present technology will be described below with reference to FIG. 2.

Referring now to FIG. 1, illustrated therein is a high level schematic block diagram that is used to show an exemplary system 100 with which embodiments of the present technology can be used. In FIG. 1, a plurality of wide field of view (FOV) capture devices 104a, 104b and 104c, are shown as capturing separate visual feeds of the same scene 102, with each of the visual feeds corresponding to a different viewpoint in actual or virtual space. The visual feed that is captured by each of the wide-FOV capture devices 104a, 104b and 104c are shown as being provided to one or more processing unit(s) 106. These processing unit(s) can be implemented using one or more general-purpose computer systems and/or special-purpose computer systems with access to real-time visual data from capture devices 104a, 104b, and 104c, as well as consumption data from a plurality of viewers 112a, 112b and 112c, and may modify the processing and/or displaying of the real-time visual data based on the real-time consumption data, as explained herein. The visual feeds are shown as being provided, via one or more data networks 110, to a plurality of viewing devices 108a, 108b and 108c, which can be referred to collectively as viewing devices 108, or individually as a viewing device 108. Such viewing devices 108 enable users, which can also be referred to as viewers, to view the captured scene 102. The viewers 112a, 112b and 112c can be referred to collectively as viewers 112 (or users 112), and can be referred to individually as a viewer 112 (or a user 112).

As can be appreciated from FIG. 1, various different types of viewing devices may be used to view the captures scene 102. For example, a television (TV) 108a, a mobile device 108b and/or a head mounted display (HMD) 108c can use one or more visual feeds to display the scene 102 to viewers. A mobile device 108b can be, e.g., a smartphone, a smartwatch, a tablet computer, or a notebook computer, but is not limited thereto. FIG. 1 also shows that the viewing devices provide consumption data, via the data network(s) 110, to the processing unit(s) 106. The data network 110 can include a local area network (LAN), a wide area network (WAN), a wireless network, an intranet, a private network, a public network, a switched network, or combinations of these, and/or the like, and may include the Internet.

FIG. 2 is a high level schematic block diagram that is used to show an exemplary 360 degree camera 204 type wide-FOV capture device 104 with which embodiments of the present technology can be used. Referring to FIG. 2, the 360 degree camera 204 is shown as including wide-FOV lenses 201a, 201b, 201c and 201d, image sensors 202a, 202b, 202c and 202d, and one or more processing unit(s) 203. Each of the wide-FOV lenses 201a, 201b, 201c and 201d can collect light from a respective wide-FOV, which can be, e.g., between 120-220 degrees of the field. A radial lens/sensor arrangement is shown, but a wide variety of different arrangements can alternatively be used, and are within the scope of the embodiments described herein. More or less lenses and image sensors than shown can be used. The camera 204 can provide a full 360-degrees of coverage, but in alternative embodiments, coverage of a full sphere need not be provided. Each of the lenses 201a, 201b, 201c and 201d focuses a respective image onto a respective one of the imaging sensors 202a, 202b, 202c and 202d, with lens distortion occurring due to the wide-FOV. Each of the imaging sensors 202a, 202b, 202c and 202d converts light incident on the sensor into a data signal (e.g., which can include RGB data, but is not limited thereto). The processing unit(s), which can be embedded within a camera body, receive the data signals from the imaging sensors 202a, 202b, 202c and 202d and perform one or more imaging processing steps, before sending one or more image frames on an outbound data feed. These image processing steps can include, but are not limited to: debayering, dewarping, color correction, stitching, image compression, and/or video compression.

In accordance with an exemplary embodiment, an event, for example a soccer game, is captured and broadcast using a plurality of 360-degree cameras (e.g., 204) or other wide field of view cameras or other capture devices (referred to collectively as “wide-FOV” capture devices). In accordance with certain embodiments, each wide-FOV capture device provides a separate video feed, among which viewers may be able to choose. Besides 360 degree cameras or other wide-FOV cameras, other types of wide-FOV capture devices include, but are not limited to, light-field cameras, light detection and ranging (LIDAR) sensors, and time-of-flight (TOF) sensors.

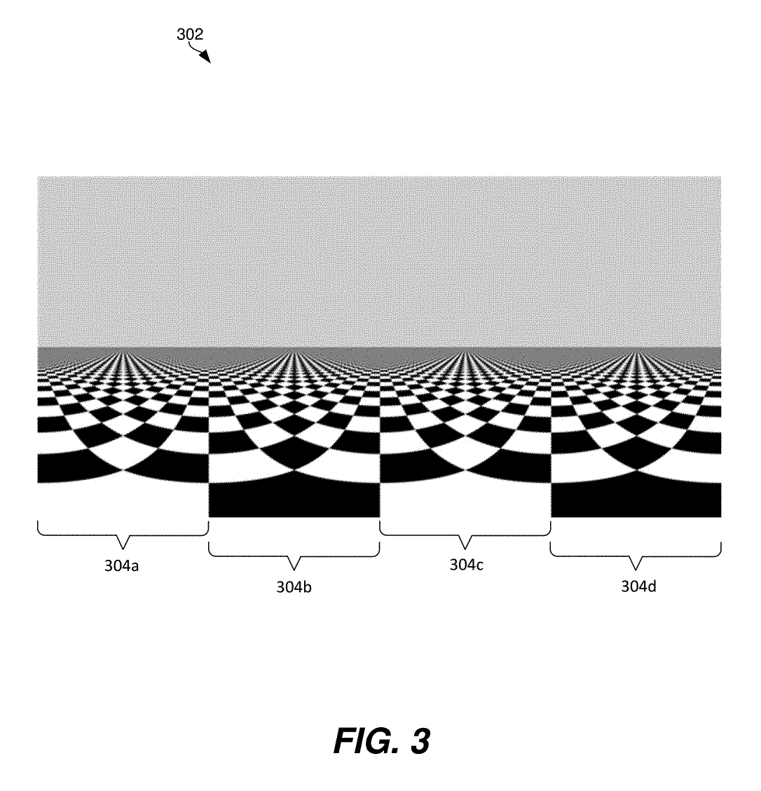

Viewers can consume the various video feeds via different types of transmission media and devices—delivered by wired or wireless means to head-mounted displays (HMDs), mobile devices, set-top boxes, and/or other video playback devices. In many of these consumption modalities, at any given time the field of view (FOV) of the video feed well exceeds the FOV shown on the display. In other words, the full field of content is larger than the FOV that can be viewed by any individual viewer at a given time. In an exemplary embodiment, a full 360-degree video may be represented in an equirectangular projection 302, an example of which is shown in FIG. 3. Referring to FIG. 3, the equirectangular projection 302 is shown as being made up of four sub-regions 304a, 304b, 304c, and 304d, each of which corresponds to 90-degrees of video. The sub-regions 304a, 304b, 304c, and 304d can be referred to individually as a sub-region 304, or collectively as the sub-regions 304. It would also be possible that an equirectangular projection include more or less than four sub-regions. The actual FOV within a typical HMD is constrained on both the vertical and horizontal axis; typically around 100 degrees horizontal (combining the FOV of both eyes) and about 100 degrees vertical.

Each viewer, in the process of viewing one or more visual feeds, causes “consumption data” to be generated which is fed back to the system to enable the creation of attention volumes, or more specifically, 3D volumetric level of interest data. Such consumption data, as will be described in more detail below, can be generated by an HMD, and/or another other type of device (e.g., a mobile device) that includes or is in communication with cameras, inertial measurement units (IMUs), gyroscopes, accelerometers, and/or other types of sensors that can be used to track which portion(s) of a 3D scene the viewer is consuming, wherein such tracking can involve gaze tracking, head tracking, and/or tracking of other types of user inputs, but is not limited thereto. This consumption data can specify which portions of which visual feeds are consumed and for how long, and can also specify specific user behavior data as to how those feeds are consumed.

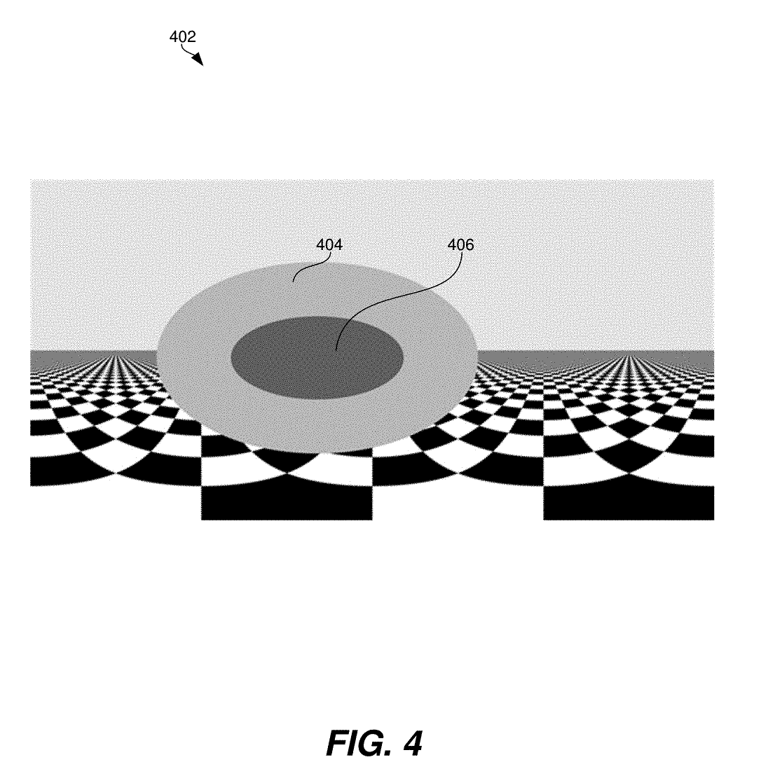

In order to consume the full 360 degree field of content, or some other wide-FOV, viewers can pan, tilt and/or zoom the image via user input. For example, HMD users can rotate their heads to follow the action. However, users on other devices would typically have other means to pan, tilt, or zoom the video feed—e.g., by dragging a finger across a mobile device screen or touchpad, maneuvering a mouse or joystick, and/or the like. Gaze tracking data, indicating a direction of a viewer's gaze, may also be generated. Whichever way the viewing area is changed, the position of the viewing area serves as an excellent proxy for the areas of the wide-FOV visual feed which attract various degrees of interest (which can also be referred to as degrees of attention), including the area of highest interest (which can also be referred to as the area of highest attention). Such an “attention area” may be visualized or represented by superimposing it upon the equirectangular projection, as shown in FIG. 4. In FIG. 4, the light gray area 404 in the equirectangular projection 402 represents the full viewable FOV for a single viewer, while the dark gray area 406 represents the center of that FOV. It can be presumed that viewers pan, tilt, and/or zoom the image so as to orient the area deserving of their attention at or near the center of their FOV. Accordingly, applying that presumption, at any given time, the area corresponding to the center of a user's FOV, such as the area 406 in FIG. 4, can be identified as the area of greatest interest to the user. It is noted that the terms “viewers” and “users” are used interchangeably herein. It is also noted that the terms “interest” and “attention” are typically used interchangeably herein.

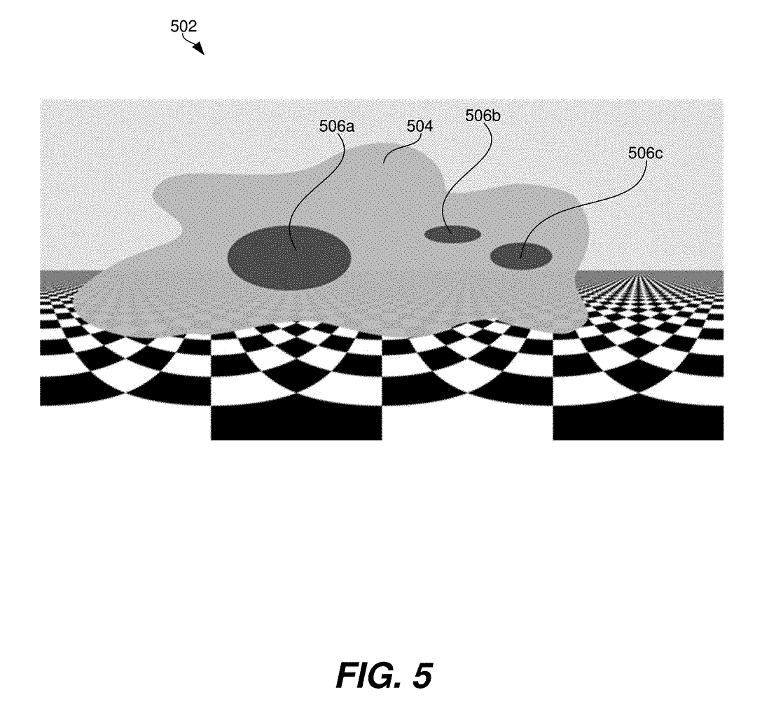

The consumption data associated with multiple users viewing any single visual feed can be aggregated, either in real-time or in post-processing, to calculate the overall aggregate area(s) of interest (“attention area(s)” or “heat map”) for the content shown in that visual feed. The “attention area(s)” calculations can be updated at whatever rate user consumption data is sampled, often as high as 120 Hz, and the data can be fed back in real time to the production to add value in a variety of ways. An example of such a “heat map” overlaid on an equirectangular projection 502 is shown in FIG. 5, wherein several areas of high interest 506, shown in dark gray regions individually labeled 506a, 506b, and 506c, are ascertained from the overlap of a number of users' individual “attention areas.” In FIG. 5, the light grey area 504 represents the aggregated full FOV from the multiple users.

Alternatively, in accordance with certain embodiments of the present technology, the “attention area(s)” data from multiple viewers' consumption of multiple visual feeds are synchronized and combined (i.e., aggregated) to create one or more “attention volume(s)” for an entire real or virtual scene, which can change over time. Once generated, the “attention volume(s)” data can be used, either in real-time or in post-processing, to enable a variety of novel optimizations, some examples of which are described further below. Attention volume(s) data can also be referred to herein as 3D volumetric level of interest data.

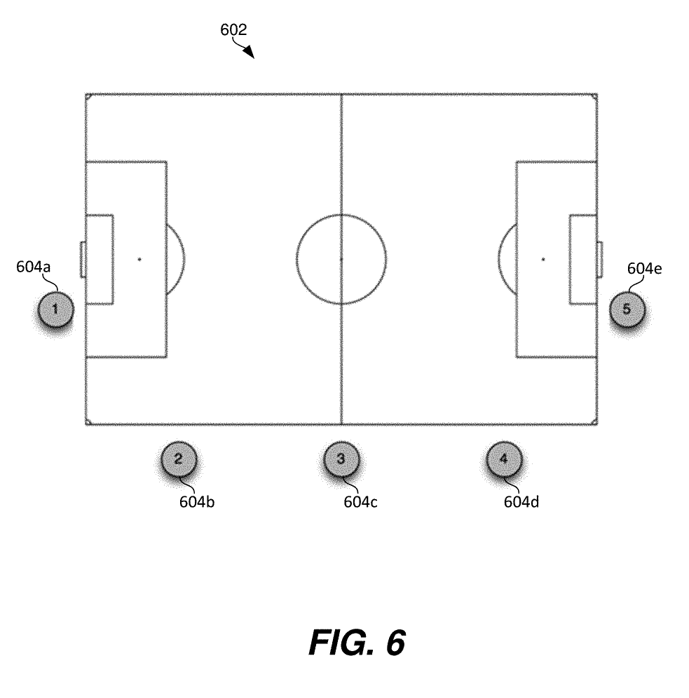

The two-dimensional (2D) diagrams shown in FIGS. 6-8 illustrate how viewer consumption data from multiple spherical or wide-FOV visual feeds with known locations in actual or virtual space can be obtained and combined in order to generate an attention volume, which can also be referred to as a “volume of interest”. In other words, the terms “attention volume” and “volume of interest” are referred to interchangeably herein. The data indicative of a volume of interest is referred to herein as 3D volumetric level of interest data.

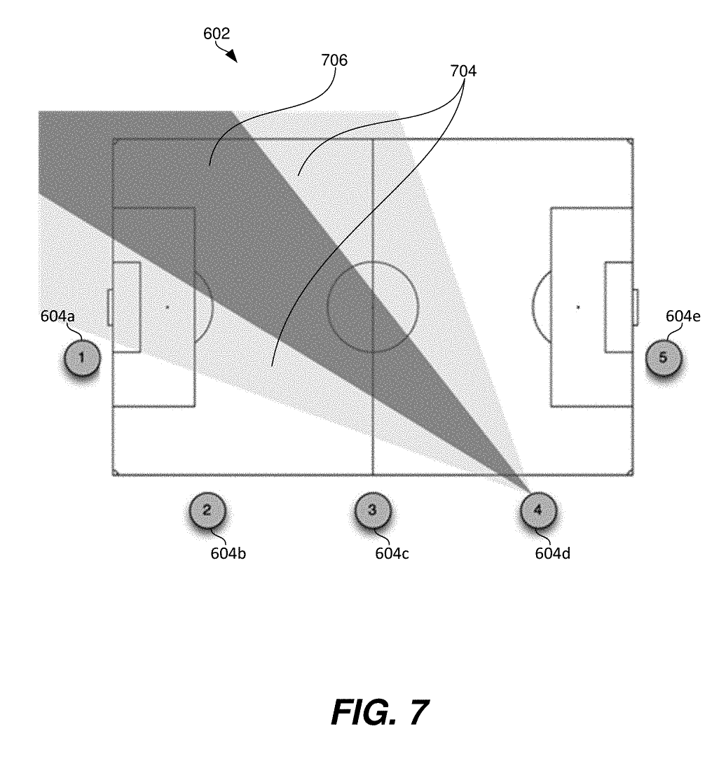

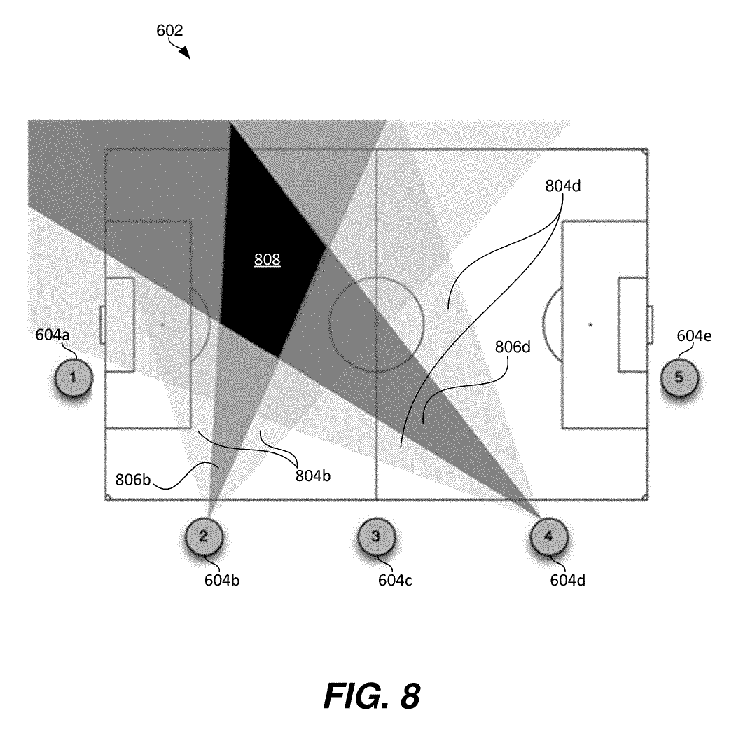

For example, FIG. 6 illustrates how five wide-FOV capture points 604a, 604b, 604c, 604d, and 604e can be positioned around a periphery of a scene, in this case a soccer field 602, in order to obtain five separate visual feeds of the same scene, with each of the visual feeds corresponding to a different viewpoint in actual or virtual space. The capture points 604a, 604b, 604c, 604d, and 604e can be referred to individually as a capture point 604, or collectively as the capture points 604. While five capture points 604 are shown in FIG. 6 (and FIGS. 7 and 8), more or less than five capture points 604 can be used. Where the scene is in the real-world, each capture point 604, which obtains a separate visual feed of the same scene, can be implemented using a wide-FOV capture device, such as a 360-degree camera, a wide-FOV camera, a light field capture device, but is not limited thereto. In other words, the scene may be in the real-world, with visual feeds captured using 360-degree cameras or other sensor devices. Alternatively, where the scene is a computer rendered 3D scene, the visual feeds can be captured virtually. Accordingly, where the scene is a computer rendered 3D scene, each of the capture points 604 need not be implemented by camera or other capture device, but rather, can represent a different viewpoint in virtual space. Each visual feed from the multiple capture points 604 can be viewed by zero, one, or multiple different viewers, whom can also be referred to as users. In doing so, at each moment, each viewer chooses a limited field of view for actual consumption (whether via head rotation or other means). As a single viewer may not, for a variety of reasons, be oriented towards the most generally interesting direction, typically such data is aggregated across a number of viewers. Typically the aggregate consumption data is represented as a “heat map,” where areas of attention are projected onto a spherical surface (e.g., as represented in FIG. 4). Various embodiments of present technology described below use this data differently.

Attention volume generation processes, according to certain embodiments of the present technology, will now be described below. An exemplary single-view-point “attention volume” determined based on a single capture point's visual feed for a single moment in time is shown in FIG. 7. Elements in FIG. 7 that are labeled the same as in FIG. 6 represent the same elements, and need not be described again. Based on the “attention area” consumption data from the viewpoint of a single capture device (labeled 604d), a potential attention volume can be estimated. Referring to FIG. 7, the dark shaded area labeled 706 indicates high attention, and light shaded areas labeled 704 indicate moderate attention. (This is a 2D representation of what would be a 3D volume, in this case a cone constrained by the ground plane.)

While a single visual feed can be used to determine a two-dimensional (2D) attention area (which can also be referred to as an “area of interest”), a single visual feed is suboptimal for determining an attention volume (which, as noted above, can also be referred to as a “volume of interest”). This is because while the orientation of the potential volume of interest can be determined based on the consumption data from a single capture point, and the shape of the volume may be constrained by known information about scene geometry (e.g. the ground plane), without more information the accurate shape of a volume of interest can only be roughly inferred, not fully determined. In particular, there is no information extending along the Z axis from the camera location—that is, one can only guess how far away any object or volume of interest might be from the camera or other capture point location.

Making use of one or more additional consumption data set(s) associated with one or more other viewers consuming one or more other video feeds within the same scene can be used to solve this problem. Through triangulation, the potential volumes of interest can be dramatically narrowed. A simple example of the triangulation process is shown in FIG. 8. Referring to FIG. 8, an attention volume generated by consumption data from the capture point 604d is shown as being overlaid by a separate attention volume generated by consumption data from the capture point 604b. This use of an additional data source allows the distribution of viewer attention through the 3D space to be more accurately determined. More specifically, in FIG. 8 the dark shaded area labeled 806d indicates high attention from the capture point 604d, and light shaded areas labeled 804d indicate moderate attention from the capture point 604d. The dark shaded area labeled 806b indicates high attention from the capture point 604b, and light shaded areas labeled 804b indicate moderate attention from the capture point 604b. With the additional consumption data, the volume of highest interest can be constrained to the darkest area, labeled 808.

Extrapolating this technique further, consumption data can be combined (i.e., aggregated) from multiple viewers of multiple video feeds using a variety of weighting, smoothing, and other data summary techniques. For example, outlier data can be identified and overweighted or underweighted. Additionally, or alternatively, data can be smoothed over several frames. It would also be possible to differently weight different users. For example, the weights applied to particular users can differ based on demographic and/or other data, as an expert viewer's attention might be more valuable for some purposes than a novice viewer's.

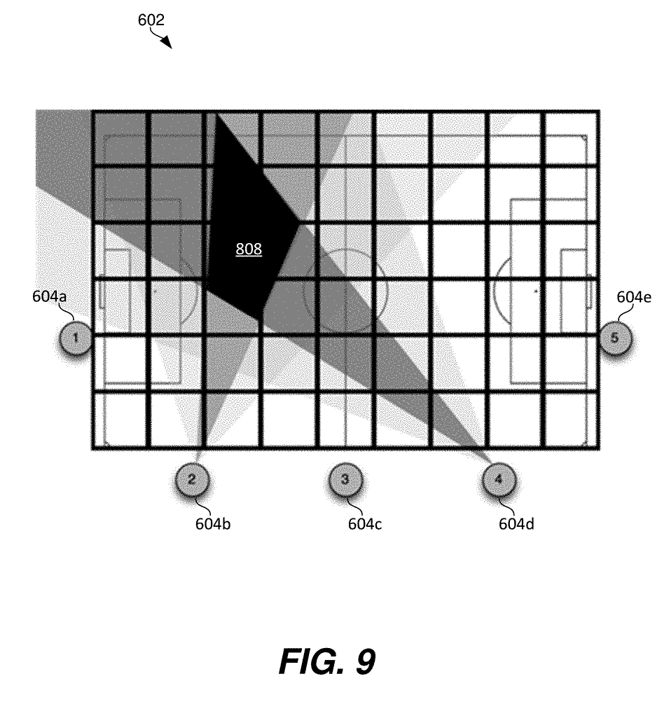

In certain implementations, a voxel-based approach can be employed, wherein the relevant scene volume is divided into three-dimensional cubes, with each cube assigned a scalar value corresponding to the combined attention directed towards that voxel from all viewers. This methodology is represented in FIG. 9, wherein each square of the grid shown in FIG. 9 corresponds to a voxel, which is a three-dimensional cube. In accordance with certain embodiments, for each time slice, which in a typical implementation can correspond to a video frame, the values for each voxel are recalculated. This time sequence of attention volumes can be calculated to as fine a four-dimensional resolution as is desired. This 4D “attention volume” sequence can in turn be used to drive a wide variety of further optimizations, examples of which are described further below.

As will be described below, user consumption data can be derived from a variety of different types of sources.

With wide-FOV-video based content consumed via a headset, such as a head mounted display (HMD), but not limited thereto, consumption data can be derived from head rotation, gaze direction, foveal convergence, and/or zoom level.

With wide-FOV-video based content consumed via a handheld device, desktop device, or set-top box, consumption data can be derived from the user-controlled pan, tilt, and zoom of the “viewing window” as indicated by finger scrolling, mouse control, touchpad control, joystick control, remote control, and/or any other means.

With synthetic computer-generated or “free viewpoint video” content, which allows so-called “6-degrees-of-freedom” of movement for users, there is considerably more data available. In such content, each viewer is able to move freely through the three-dimensional space, so the user's “virtual location” within the scene, as well as the viewing orientation and zoom level, can serve as inputs to the consumption data aggregation process. This can be conceived as an extrapolation of certain embodiments described above, where rather than having several cameras from which many users obtain a viewpoint, each user has a single “virtual camera” of their own.

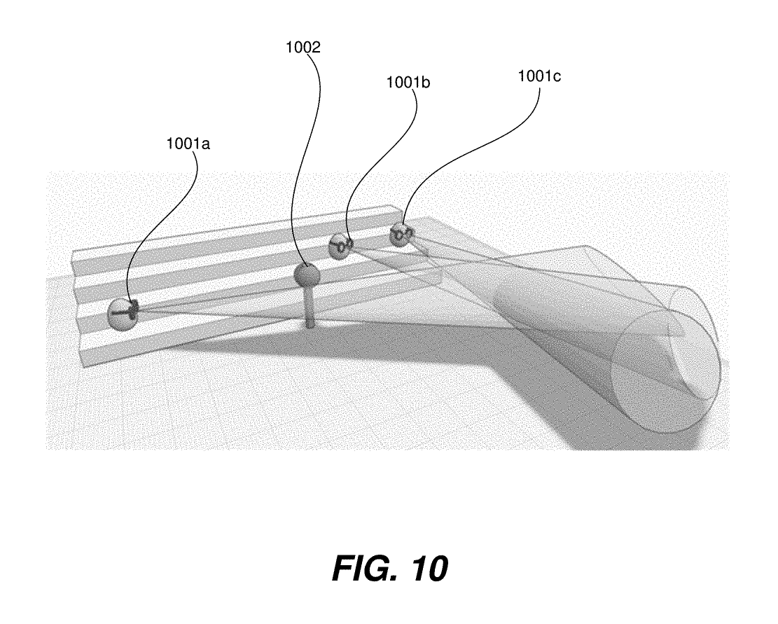

In an alternate embodiment, rather than deriving consumption data from viewers of video feeds, consumption data can be derived from local viewers of a real-world event, such as local viewers of a soccer game, and that data may serve as an input to the attention volume generation system. This methodology is represented in FIG. 10. In accordance with certain embodiments, attention volume is generated based on head pose and location data from local viewers, labeled 1001a, 1001b, and 1001c. Head pose data can be obtained by various different means including, but not limited to, augmented reality headsets worn by several local viewers, and/or analysis of head pose from visual data. In certain embodiments, local viewers wear augmented reality headsets, either with or without displays, and head pose data from these devices is collected in real time. Such headsets can include sensors (e.g., one or more inertial measurement units (IMUs), accelerometers, magnetometers, and/or gyroscopes) that obtain, or are used to obtain, the head pose data. Where a sensor is included in a headset or something else that is worn or otherwise attached by a viewer, it can be said that the sensor is attached to the viewer. Alternatively, or additionally, one or more cameras trained on viewers of a scene can estimate the head pose of one or more viewers using one or more of a variety of published techniques, including computer vision and/or eye tracking, but not limited thereto. The location of these viewers relative to a scene being viewed and/or a desired attention volume can also be known or derived from, e.g., known locations of seats in a stadium, and/or GPS data, but is not limited thereto. In FIG. 10, a single wide-FOV camera 1002 is used to capture both the scene itself and images of viewers for estimation of head pose and location. Alternatively, different cameras can be used to capture the scene than is/are used to capture images of viewers from which head pose and/or location data can be estimated. The combination of head pose and location data can be used to generate a potential attention volume for each local viewer, and data from multiple real-world viewers could serve as an alternate or additional input to the aggregate attention volume generation system described above. The use of locally-derived consumption data has the benefit of reducing the latency imposed by remote viewership data.

Additional Data Sources: User consumption data may not be the only input to the “attention volume” generation process. A number of other data sources, examples of which are discussed below, can alternatively or additionally be used to create a more accurate 3-D attention volume.

Scene geometry: Scene geometry can inform the attention volume, by, for example, indicating solid planes or shapes which cannot be seen through by viewers, allowing the possible “attention area” to be constrained to regions that can actually be seen by the viewers. Even crude scene geometry (e.g., ground plane information) can increase accuracy and reduce computation times. For example, areas that are below a ground plane and are thus not viewable to users (assuming the ground plane is not transparent, as may be the case if the ground plane represents water) can be assumed to not be included in the attention area. Scene geometry can be independently obtained (e.g. by getting an architectural map of a stadium in advance) and/or derived from the scene via a variety of well-known means (visual disparity, LIDAR, etc). In synthetic computer generated scenes, as in multiplayer video games, the scene geometry is known and can be easily used as an input to the process.

Object, motion and face recognition: Attention volumes can be more accurately inferred—or even predicted—via the use of content-based analysis. In accordance with certain embodiments, object and/or face recognition is used to allow the “attention volume” generation process to obtain higher resolution of expected attention regions. In accordance with certain embodiments, motion analysis is used to permit the system to predict future attention volumes in advance. Implementations of these analyses can employ deep learning techniques, but are not limited thereto.

Third-party position data: Especially for sports, entertainment and military applications, telemetry or other real-time data feeds indicating the position of key actors or objects within the scene are often available. This type of data can also serve as an input into the “attention volume” generation process.

Potential Uses of the Attention Volume Data are described below.

Automated content production: The attention volume data can be used to drive or inform real-time or post-event content production. There are a number of potential implementations, examples of which are described below.

In certain embodiments, involving multiple camera feeds, the attention volume can be used to create an automated switched feed, wherein multiple feeds are used at various points in time to provide a single feed which follows the action. The system can switch among cameras, insert video overlay from other cameras, and pan and tilt a spherical 360 degree or other video feed to show the best view of the most interesting part of the scene at all times, based on the consumption data.

The wide-FOV “attention volume” could also be used to similarly drive camera control and video switching for a standard rectangular-frame video production. Automated robotic cameras can be panned, tilted and zoomed to capture the high-interest areas of the scene, as determined by the attention volume. Not only could this alleviate the need for people to control the panning, tilting and zooming of individual cameras, this could also alleviate (or at least assist with) certain video production tasks related to switching among different camera feeds.

In accordance with certain embodiments, the two production implementations introduced above are combined. In parallel to the wide-FOV visual feed output, the system could create a standard rectangular-frame TV output, by autonomously cropping the wide-FOV feeds to create standard video feeds. In this way, a complete switched video feed for standard video users can be essentially “authored” automatically by the attention behavior of local viewers and/or remote wide-FOV feed viewers.

In accordance with certain embodiments, attention volume data is used to drive automated production of post-event content, for example, by creating a highlight reel summarizing portions of the event that enjoyed the most concentrated interest. For a more specific example, portions of one or more video feeds that have a level of interest from viewers that exceed a specified threshold can be autonomously aggregated to autonomously generate a highlight reel of an event, such as a soccer game.

In accordance with certain embodiments, attention volume data is used to drive the display of augmented reality content in real time. For example, in specific embodiments, if the attention volume data from multiple viewers indicates that a high amount of attention is directed towards an individual player on a soccer field, the system will display statistics and/or other contextual content on that player automatically, to be viewed by local viewers using AR glasses, remote viewers using VR goggles, and/or by standard TV audiences. Contextual content, and the data indicative thereof, can be, e.g., information about someone or something that is being viewed, such as statistical and background information about a specific soccer player that a majority of viewers are watching. Statistic contextual content can, e.g., indicate how many goals that specific soccer player has scored during the current game, the current season and/or during their career. Background contextual content about the specific play can, e.g., specify information about World Cup and/or All-Start teams on which the player was a member, the country and city where the player was born, the age of the player, and/or the like. Contextual information can also be autonomously obtained and displayed for animals within a scene, inanimate objects within a scene, or anything else within a scene where there is a high amount of attention directed. These are just a few examples of contextual data that can be autonomously obtained and overlaid onto a video stream that is being viewed. Such contextual data can be displayed on the display of AR glasses, VR goggles, some other type of HMD, a TV, a mobile device (e.g., smartphone), and/or the like. Computer vision, facial recognition, and/or the like, can be used to identify a person or object within a volume of high interest, and then contextual content can be obtained from a local data store and/or a remote data store via one or more data networks (e.g., 130 in FIG. 1). Such contextual data may be displayed in real-time in response to live user attention data during a live event, or may be added in post-processing to renditions of recorded content, based on user attention data accumulated from earlier renditions of the same content.

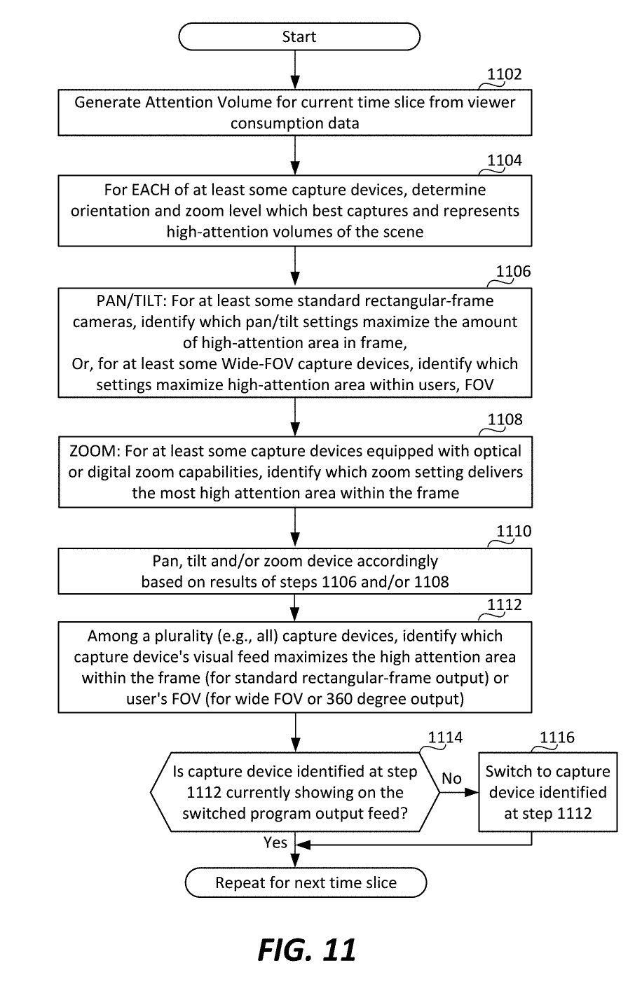

A high level flow diagram that is used to summarize autonomous camera management and switching, according to certain embodiments of the present technology, is shown in FIG. 11. Referring to FIG. 11, step 1102 involves generating attention volume data for a current time slice from viewer consumption data. Step 1104 involves, for each of at least some of a plurality of capture devices (e.g., cameras), determining an orientation and a zoom level which best captures and represents one or more high-attention volumes of the scene. In certain embodiments, a high-attention volume is an attention volume where the level of interest exceeds a specified threshold, or simply is the highest for the scene. At step 1106 preferred pan and tilt setting are identified. This can involve, for at least some standard rectangular-frame cameras, identifying which pan/tilt setting maximize the amount of high-attention area within a frame. Alternatively, or additionally, step 1106 can involve, for at least some wide-FOV capture devices, identifying which pan/tilt setting maximize the high-attention area within the users' FOV. Still referring to FIG. 11, at step 1108 a preferred zoom setting is identified. This can involve, for at least some of the capture devises equipped with optical or digital zoom capabilities, identifying which zoom settings provides the most high-attention area within the frame.

Still referring to FIG. 11, step 1110 involves applying the preferred pan, tilt and/or zoom setting identified at steps 1106 and/or 1108. Step 1112 involves identifying, from among a plurality (e.g., all) capture devices (e.g., cameras), which capture device's visual feed maximizes the high attention area with the frame (for standard rectangular-frame output) or users' FOV (for a 360 degree FOV or some other wide-FOV output). At step 1114 there is a determination of whether the capture device identified at step 1112 is currently showing on a switched program output feed. If the answer to the determination at step 1114 is No, then at step 1116 there is a switch to the capture device identified at step 1112, and flow returns to step 1102 for the next time slice. If the answer to the determination is Yes, meaning the capture device identified at step 1112 is current showing on the switched current feed, and then the above described steps are repeated fora next time slice, i.e., flow returns to step 1102 for the next time slice.

Optimizing physical (i.e., real-world) capture device position: In situations where real-world capture devices (primarily cameras, but potentially also microphones) can be moved, consumption data can be used to position capture devices in 3-dimensional space so as to bring them closer to high-attention areas. More specifically, the position (also referred to as location) of a SkyCam, cable-mounted camera, or drone camera might be driven automatically by the attention volume.

Optimizing virtual camera position: in situations where visual feeds may be generated from virtual cameras, whether for synthetic or real-world 3D scenes, consumption data may be used to identify the optimal position and orientation of one or more virtual cameras in 3D virtual space so as to optimally display high-attention areas.

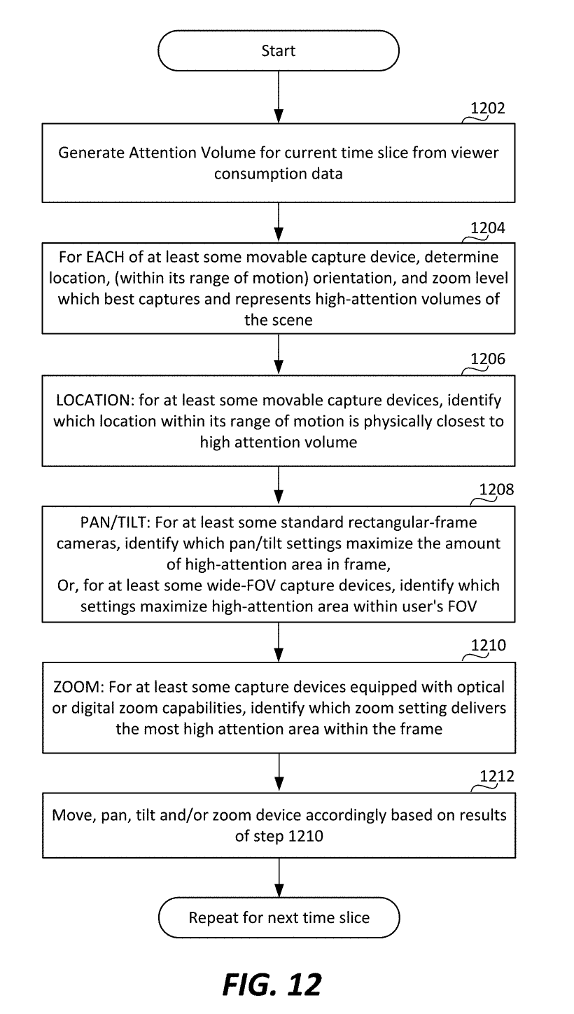

A high level flow diagram that is used to summarize autonomous positioning of capture device(s) in three dimensional space so as to bring it/them closer to high-attention areas, according to certain embodiments of the present technology, is shown in FIG. 12. Such embodiments are especially useful for positioning movable capture devices, such as a SkyCam, cable-mounted camera, or drone camera, but not limited thereto. Referring to FIG. 12, step 1202 involves generating attention volume data for a current time slice from viewer consumption data. Step 1204 involves, for each of at least some of a plurality of movable capture devices (e.g., cameras), determining a location, orientation, and zoom level which best captures and represents one or more high-attention volumes of the scene. In certain embodiments, a high-attention volume is an attention volume where the level of interest exceeds a specified threshold, or simply is the highest for the scene. Step 1206 involves, for at least some of the movable capture devices, identifying which location within its range of motion is physically closest to the high-attention volume. At step 1208 preferred pan and tilt setting are identified. This can involve, for at least some standard rectangular-frame cameras, identifying which pan/tilt setting maximize the amount of high-attention area within a frame. Alternatively, or additionally, step 1208 can involve, for at least some wide-FOV capture devices, identifying which pan/tilt setting maximize the high-attention area within the users' FOV. Still referring to FIG. 12, at step 1210 a preferred zoom setting is identified. This can involve, for at least some of the capture devises equipped with optical or digital zoom capabilities, identifying which zoom settings provides the most high-attention area within the frame.

Still referring to FIG. 12, step 1212 involves moving a movable capture device to the location identified at step 1206, and applying the preferred pan, tilt and/or zoom setting identified at steps 1208 and/or 1210. The above described steps are repeated for a next time slice, i.e., flow returns to step 1202 for the next time slice.

Compression Efficiency: The consumption data can be used to drive or inform real-time or post-event compression settings.

For video-based implementations, HEVC and other modern video codecs permit the allocation of different compression rates to different regions of the video field. The attention volume can be used to drive this allocation, applying higher compression rates to regions of the video field that correspond to low-interest areas of the capture space.

In accordance with certain embodiments, this consumption data can be applied to increase the efficiency of volumetric or point-cloud compression techniques. For example, the consumption data can be used to indicate which volumes of the scene deserve more bits for their representation.

Maintaining Consumption Data Integrity: In accordance with certain embodiments, where the consumption data is used to autonomously drive the production of a switched video feed, the system runs the risk of being the victim of its own success. That is, users can choose to view the switched feed rather than selecting individual camera views, thus depriving the attention volume generation process of the triangulation data it uses to autonomously drive the production of the switched video feed. This phenomenon will to some degree be self-correcting—if the switched feed is not very good, viewers will try to do the job themselves by choosing alternate camera feeds—but it may be a good idea to anticipate this problem and avoid it when possible. For example, in accordance with certain embodiments, in order to generate sufficient triangulation data, the system can deliberately show sub-optimal feeds to a subset of the audience. This could be implemented so as to maximize the orthogonality of the attention data thus received. The specific subset of the audience that is shown sub-optimal feeds can be changed over time, so as to not disgruntle specific viewers.

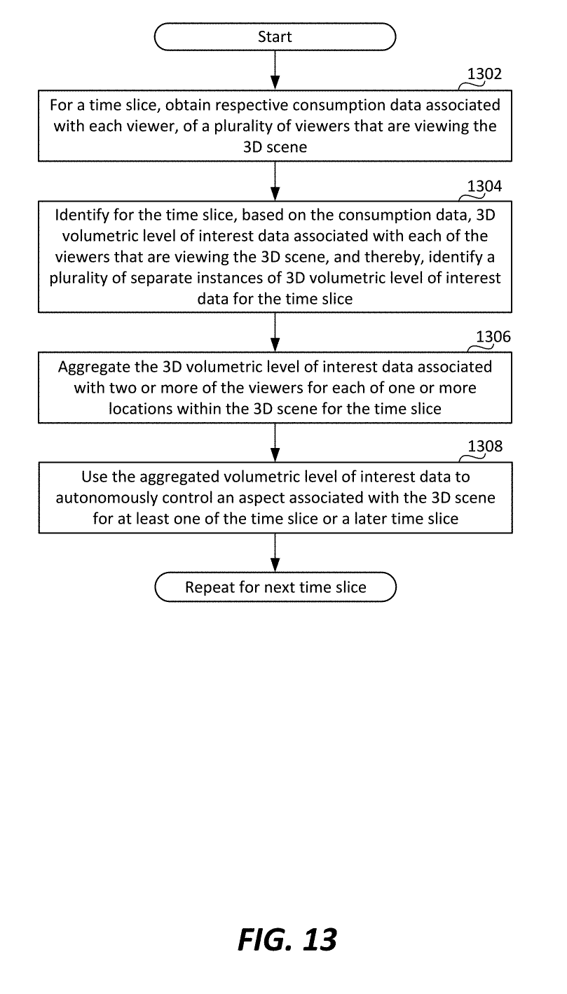

FIG. 13 is a high level flow diagram that is used to summarize methods according to various embodiments of the present technology. More specifically, such methods can be used to identify and use three-dimensional (3D) volumetric level of interest data associated with a 3D scene that is being viewed by multiple viewers. Referring to FIG. 13, step 1302 involves, for a time slice, obtaining respective consumption data associated with each viewer, of a plurality of viewers that are viewing the 3D scene. In certain embodiments, the 3D scene is a real-world scene captured using one or more wide-FOV capture devices, and at least some of the viewers are using viewing devices to view the 3D scene based on one or more video feeds generated using at least wide-FOV capture device. In certain such embodiments, each time slice can correspond to a frame of video captured by at least one of the one or more wide-FOV capture devices. Such a real-world scene can be captured using a plurality of wide-FOV capture devices that each have a respective viewpoint that differs from one another. In alternative embodiments, the 3D scene that is being viewed is a computer rendered virtual scene, in which case each time slice can correspond to a rendered frame of the virtual scene. In certain such embodiments, each of the viewers can view the computer rendered virtual scene from respective viewpoints that can differ from one another.

Still referring to FIG. 13, step 1304 involves identifying for the time slice, based on the consumption data, 3D volumetric level of interest data associated with each of the viewers that are viewing the 3D scene, and thereby, identifying a plurality of separate instances of 3D volumetric level of interest data for the time slice. For example, referring briefly back to FIG. 10, 3D volumetric level of interest data associated with a first viewer 1001a can correspond to the cone shown extending from the first viewer 1001a, 3D volumetric level of interest data associated with a second viewer 1001b can correspond to the cone shown extending from the second viewer 1001b, and 3D volumetric level of interest data associated with a third viewer 1001c can correspond to the cone shown extending from the third viewer 1001c.

Referring again to FIG. 13, step 1306 involves aggregating the 3D volumetric level of interest data associated with two or more of the viewers for each of one or more locations within the 3D scene for the time slice. In accordance with certain embodiments, step 1306 includes aggregating the 3D volumetric level of interest data associated with two or more of the viewers for each of one or more locations within the 3D scene, by identifying where at least some of a plurality of separate 3D volumes of interest identified for the time slice overlap one another. Referring briefly back to FIG. 10 again, in accordance with certain embodiments, at step 1308 an identified 3D volume of high interest can be a volume that is intersected by at least a majority of the cones shown in FIG. 10. This is just one example of how the aggregating can be performed at step 1306, which is not intended to be limiting.

Referring again to FIG. 13, step 1308 involves using the aggregated volumetric level of interest data to autonomously control an aspect associated with the 3D scene for at least one of the time slice or a later time slice. For example, step 1308 can include, for at least one of the time slice or a later time slice (e.g., a current frame or a later frame), rendering one or more 3D volume(s) of high interest at a higher resolution than another portion of the 3D scene that is outside the 3D volume(s) of high interest. Alternatively, or additionally, step 1308 can include, for at least one of the time slice or a later time slice, compressing image data corresponding to one or more 3D volume(s) of high interest at a lower compression ratio than another portion of the 3D scene that is outside the 3D volume(s) of high interest.

In accordance with certain embodiments, the 3D scene that is being viewed is a real-world scene and step 1308 includes, for at least one of the time slice or a later time slice, autonomously controlling a location of at least one real-world capture device that is used to capture content of the 3D scene that is viewable by the multiple viewers. Examples of such real-world capture devices include, but are not limited to, a SkyCam, a cable-mounted camera, or a drone camera. Additionally, or alternatively, step 1308 can include, for at least one of the time slice or a later time slice, autonomously controlling pan, tilt and/or zoom of at least one capture device (e.g., camera) that is used to capture content of the 3D scene that is viewable by the multiple viewers.

In accordance with certain embodiments, where the 3D scene that is being viewed is a real-world scene, step 1308 includes, for at least one of the time slice or a later time slice, autonomously adding contextual information about a person or object within a 3D volume of high interest so that the added contextual information is viewable by the multiple viewers. Such contextual information can be statistical information and/or background information about a person or object within the 3D volume of high interest, but is not limited thereto.

In accordance with certain embodiments, where the 3D scene that is being viewed is a computer rendered virtual scene, step 1308 includes, for at least one of the time slice or a later time slice, autonomously controlling a location of at least one virtual capture device that is used to capture content of the 3D scene that is viewable by the multiple viewers.

Embodiments of the present technology have been described above with the aid of functional building blocks illustrating the performance of specified functions and relationships thereof. The boundaries of these functional building blocks have often been defined herein for the convenience of the description. Alternate boundaries can be defined so long as the specified functions and relationships thereof are appropriately performed. Any such alternate boundaries are thus within the scope and spirit of the claimed invention. For example, it would be possible to combine or separate some of the steps shown in FIGS. 11, 12 and 13.

The disclosure has been described in conjunction with various embodiments. However, other variations and modifications to the disclosed embodiments can be understood and effected from a study of the drawings, the disclosure, and the appended claims, and such variations and modifications are to be interpreted as being encompassed by the appended claims.

In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate, preclude or suggest that a combination of these measures cannot be used to advantage.

A computer program may be stored or distributed on a suitable medium, such as an optical storage medium or a solid-state medium supplied together with, or as part of, other hardware, but may also be distributed in other forms, such as via the Internet or other wired or wireless telecommunication systems.

It is understood that the present subject matter may be embodied in many different forms and should not be construed as being limited to the embodiments set forth herein. Rather, these embodiments are provided so that this subject matter will be thorough and complete and will fully convey the disclosure to those skilled in the art. Indeed, the subject matter is intended to cover alternatives, modifications and equivalents of these embodiments, which are included within the scope and spirit of the subject matter as defined by the appended claims. Furthermore, in the above detailed description of the present subject matter, numerous specific details are set forth in order to provide a thorough understanding of the present subject matter. However, it will be clear to those of ordinary skill in the art that the present subject matter may be practiced without such specific details.

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

The computer-readable non-transitory media includes all types of computer readable media, including magnetic storage media, optical storage media, and solid state storage media and specifically excludes signals. It should be understood that the software can be installed in and sold with the device. Alternatively the software can be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) exclude (excludes) propagated signals per se, can be accessed by a computer and/or processor(s), and include volatile and non-volatile internal and/or external media that is removable and/or non-removable. For the computer, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

For purposes of this document, it should be noted that the dimensions of the various features depicted in the figures may not necessarily be drawn to scale.

For purposes of this document, reference in the specification to “an embodiment,” “one embodiment,” “some embodiments,” or “another embodiment” may be used to describe different embodiments or the same embodiment.

For purposes of this document, a connection may be a direct connection or an indirect connection (e.g., via one or more other parts). In some cases, when an element is referred to as being connected or coupled to another element, the element may be directly connected to the other element or indirectly connected to the other element via intervening elements. When an element is referred to as being directly connected to another element, then there are no intervening elements between the element and the other element. Two devices are “in communication” if they are directly or indirectly connected so that they can communicate electronic signals between them.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify different objects.

For purposes of this document, the term “set” of objects may refer to a “set” of one or more of the objects.

The foregoing detailed description has been presented for purposes of illustration and description. It is not intended to be exhaustive or to limit the subject matter claimed herein to the precise form(s) disclosed. Many modifications and variations are possible in light of the above teachings. The described embodiments were chosen in order to best explain the principles of the disclosed technology and its practical application to thereby enable others skilled in the art to best utilize the technology in various embodiments and with various modifications as are suited to the particular use contemplated. It is intended that the scope be defined by the claims appended hereto.

The previous description of the preferred embodiments is provided to enable any person skilled in the art to make or use the embodiments of the present invention. While the invention has been particularly shown and described with reference to preferred embodiments thereof, it will be understood by those skilled in the art that various changes in form and details may be made therein without departing from the spirit and scope of the invention.

What is claimed is:

1. A method for identifying and using three-dimensional (3D) volumetric level of interest data associated with a 3D scene that is being viewed by multiple viewers, the method comprising:
(a) for a time slice, obtaining respective consumption data associated with each viewer, of a plurality of viewers that are viewing the 3D scene;
(b) identifying for the time slice, based on the consumption data, 3D volumetric level of interest data associated with each of the viewers that are viewing the 3D scene, and thereby, identifying a plurality of separate instances of 3D volumetric level of interest data for the time slice;
(c) aggregating the 3D volumetric level of interest data associated with two or more of the viewers for each of one or more locations within the 3D scene for the time slice; and
(d) using the aggregated volumetric level of interest data to autonomously control an aspect associated with the 3D scene for at least one of the time slice or a later time slice.

2. The method of claim 1, wherein each of at least some of the viewers is using a respective viewing device to view the 3D scene, and wherein at least some of the consumption data is provided by one or more said viewing device.

3. The method of claim 2, wherein each said viewing device is selected from the group consisting of: a head mounted display; a television; a computer monitor; or a mobile computing device.

4. The method of claim 1, wherein each of at least some of the viewers is a local viewer of a real-world event.

5. The method of claim 4, wherein at least some of the consumption data is provided by one or more sensors attached to one or more said local viewers.

6. The method of claim 4, wherein at least some of the consumption data is provided by one or more cameras trained on one or more said local viewers.

7. The method of claim 1, wherein each of at least some of the viewers is viewing a computer rendered 3D scene from a virtual camera point of view.

8. The method of claim 7, wherein at least some of the consumption data is provided by one or more sensors attached to one or more said viewers that is/are viewing the computer rendered 3D scene.

9. The method of claim 7, wherein at least some of the consumption data is provided by one or more cameras trained on one or more said viewers that is/are viewing the computer rendered 3D scene.

10. The method of claim 1, wherein step (d) includes, for at least one of the time slice or a later time slice, rendering one or more 3D volume(s) of high interest at a higher resolution than another portion of the 3D scene that is outside the 3D volume(s) of high interest.

11. The method of claim 1, wherein step (d) includes, for at least one of the time slice or a later time slice, compressing image data associated with one or more 3D volume(s) of high interest at a lower compression ratio than another portion of the 3D scene that is outside the 3D volume(s) of high interest.

12. The method of claim 1, wherein step (d) includes, for at least one of the time slice or a later time slice, autonomously controlling pan, tilt and/or zoom of at least one capture device that is used to capture content of the 3D scene that is viewable by the multiple viewers.

13. The method of claim 1, wherein the 3D scene comprises a real-world scene and step (d) includes, for at least one of the time slice or a later time slice, autonomously controlling a location of at least one real-world capture device that is used to capture content of the 3D scene that is viewable by the multiple viewers.

14. The method of claim 1, wherein the 3D scene comprises a real-world scene and step (d) includes, for at least one of the time slice or a later time slice, autonomously adding contextual information about a person or object within a 3D volume of high interest so that the added contextual information is viewable by the multiple viewers.

15. The method of claim 1, wherein the 3D scene comprises a computer rendered virtual scene and step (d) includes, for at least one of the time slice or a later time slice, autonomously controlling a location of at least one virtual capture device that is used to capture content of the 3D scene that is viewable by the multiple viewers.

16. The method of claim 1, wherein step (c) comprises aggregating the 3D volumetric level of interest data associated with two or more of the viewers for each of one or more locations within the 3D scene, by identifying where at least some of a plurality of separate 3D volumes of interest identified for the time slice overlap one another.

17. The method of claim 1, wherein the 3D scene comprises a real-world scene captured using one or more capture devices, and wherein at least some of the viewers are using viewing devices to view the 3D scene based on one or more video feeds generated using at least one said capture device.

18. The method of claim 17, wherein each time slice corresponds to a frame of video captured by at least one of the one or more capture devices.

19. The method of claim 18, wherein the real-world scene is captured using a plurality of capture devices that each have a respective viewpoint that differs from one another.

20. The method of claim 1, wherein the 3D scene comprises a computer rendered virtual scene.

21. The method of claim 20, wherein each time slice corresponds to a rendered frame of the virtual scene.

22. The method of claim 20, wherein each of the viewers views the computer rendered virtual scene from a respective viewpoint that can differ from one another.

23. A system configured to identify and use three-dimensional (3D) volumetric level of interest data associated with a 3D scene that is being viewed by multiple viewers, the system comprising:
one or more processors configured to
obtain, for a time slice, respective consumption data associated with each viewer, of a plurality of viewers that are viewing the 3D scene;
identify for the time slice, based on the consumption data, 3D volumetric level of interest data associated with each of the viewers that are viewing the 3D scene, and thereby, identifying a plurality of separate instances of 3D volumetric level of interest data for the time slice;
aggregate the 3D volumetric level of interest data associated with two or more of the viewers for each of one or more locations within the 3D scene for the time slice; and
use the aggregated volumetric level of interest data to autonomously control an aspect associated with the 3D scene for at least one of the time slice or a later time slice.

24. The system of claim 23, wherein at least some of the consumption data is provided by one or more viewing device each of which is selected from the group consisting of: a head mounted display; a television; a computer monitor; or a mobile computing device.

25. The system of claim 23, wherein:
the 3D scene that is being viewed by multiple viewers comprises at least a portion of a real-world event; and
at least some of the consumption data is provided by one or more sensors attached to one or more local viewers and/or by one or more cameras trained on one or more local viewers.

26. The system of claim 23, wherein:
at least some of the viewers are viewing a computer rendered 3D scene from a virtual camera point of view; and
at least some of the consumption data is provided by one or more sensors attached to one or more said viewers that is/are viewing the computer rendered 3D scene, and/or at least some of the consumption data is provided by one or more cameras trained on one or more viewers that is/are viewing the computer rendered 3D scene.

27. The system of claim 23, wherein the one or more processors is/are configured to use the aggregated volumetric level of interest data, to autonomously control an aspect associated with the 3D scene for at least one of the time slice or a later time slice, in at least one the following manners:
to render one or more 3D volume(s) of high interest at a higher resolution than another portion of the 3D scene that is outside the 3D volume(s) of high interest;
to compress image data associated with one or more 3D volume(s) of high interest at a lower compression ratio than another portion of the 3D scene that is outside the 3D volume(s) of high interest;
to autonomously control pan, tilt and/or zoom of at least one capture device that is used to capture content of the 3D scene that is viewable by the multiple viewers;
to autonomously control a location of at least one real-world capture device that is used to capture content of the 3D scene that is viewable by the multiple viewers;
to autonomously add contextual information about a person or object within a 3D volume of high interest so that the added contextual information is viewable by the multiple viewers; or
to autonomously control a location of at least one virtual capture device that is used to capture content of the 3D scene that is viewable by the multiple viewers.

28. The system of claim 23, wherein the one or more processors is/are configured to aggregate the 3D volumetric level of interest data, associated with two or more of the viewers for each of one or more locations within the 3D scene for the time slice, by identifying where at least some of a plurality of separate 3D volumes of interest identified for the time slice overlap one another.

29. The system of claim 23, wherein:
the 3D scene comprises a real-world scene captured using a plurality of capture devices that each have a respective viewpoint that differs from one another;
at least some of the viewers are using viewing devices to view the 3D scene based on one or more video feeds generated using at least one said capture device; and
each time slice corresponds to a frame of video captured by at least one of the one or more capture devices.

30. The system of claim 23, wherein:
the 3D scene comprises a computer rendered virtual scene;
each time slice corresponds to a rendered frame of the virtual scene; and
each of the viewers views the computer rendered virtual scene from a respective viewpoint that can differ from one another.

31. One or more processor readable storage devices having instructions encoded thereon which when executed cause one or more processors to perform a method for identifying and using three-dimensional (3D) volumetric level of interest data associated with a 3D scene that is being viewed by multiple viewers, the method comprising:
(a) for a time slice, obtaining respective consumption data associated with each viewer, of a plurality of viewers that are viewing the 3D scene;
(b) identifying for the time slice, based on the consumption data, 3D volumetric level of interest data associated with each of the viewers that are viewing the 3D scene, and thereby, identifying a plurality of separate instances of 3D volumetric level of interest data for the time slice;
(c) aggregating the 3D volumetric level of interest data associated with two or more of the viewers for each of one or more locations within the 3D scene for the time slice; and
(d) using the aggregated volumetric level of interest data to autonomously control an aspect associated with the 3D scene for at least one of the time slice or a later time slice.
